(19) United States
(12) Patent Application Publication
(10) Pub. No.: US 2013/0155719 A1
(43) Pub. Date: Jun. 20, 2013

(54) LIGHTGUIDE AS LUMINAIRE

(71) Applicants: Robert L. Brott, Woodbury, MN (US); Michael A. Meis, Stillwater, MN (US); Karl J.L. Geisler, Saint Paul, MN (US); Raymond P. Johnston, Lake Elmo, MN (US); Charles N. DeVore, Hugo, MN (US); Kayla A. Hagens, Cottage Grove, MN (US); Jon A. Kirschhoffer, Stillwater, MN (US)

(72) Inventors: Robert L. Brott, Woodbury, MN (US); Michael A. Meis, Stillwater, MN (US); Karl J.L. Geisler, Saint Paul, MN (US); Raymond P. Johnston, Lake Elmo, MN (US); Charles N. DeVore, Hugo, MN (US); Kayla A. Hagens, Cottage Grove, MN (US); Jon A. Kirschhoffer, Stillwater, MN (US)

(73) Assignee: 3M Innovative Properties Company

(21) Appl. No.: 13/331,119

(22) Filed: Dec. 20, 2011

(51) Int. Cl. F21V 8/00

(52) U.S. Cl. 362/609; 362/612

(57) ABSTRACT

A lightguide functioning as a luminaire. The luminaire includes at least one solid state light source, such as an LED, and a lightguide configured to receive light from the solid state light source. Light from the light source is coupled into the lightguide and transported within it by total internal reflection until the light exits the lightguide. A shape of the lightguide causes and directs extraction of the light. The shape can also be used to create a particular pattern of the extracted light.

### BACKGROUND

Light emitting diodes (LEDs) are essentially point sources of light. Typically, light bulb-shaped lighting applications using LEDs have the LEDs disposed inside of a diffusing dome. The light radiates out from the LEDs through the dome in a fashion similar to an incandescent light bulb. To further control the emission, directionality, and quality of the light, these light bulb-shaped housings are put into fixtures to create luminaires, which are considered complete lighting units. Luminaires using LEDs thus typically require several components, in addition to the LEDs and diffusing dome, to function as a complete lighting unit. Accordingly, a need exists for improved and more versatile luminaires incorporating LEDs or other solid state light sources.

### SUMMARY

A luminaire, consistent with the present invention, includes at least one solid state light source and a lightguide configured to receive light from the solid state light source. Light from the light source is coupled into the lightguide and transported within it by total internal reflection until the light exits the lightguide. A shape of the lightguide causes extraction of the light from the lightguide. The shape also directs the extracted light from the lightguide and can cause the light to be extracted in a particular pattern.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of a luminaire;

FIG. 2 is a side sectional view of the luminaire of FIG. 1;

FIG. 3 is an end sectional view of the luminaire of FIG. 1;

FIG. 4 is a side sectional view of an alternative embodiment of the luminaire of FIG. 1;

FIG. 5 is a side partial sectional view of the lightguide of FIG. 1 illustrating parameters for use in designing the lightguide;

FIG. 6 is a side sectional view of another luminaire;

FIG. 7 is a perspective view of the luminaire of FIG. 6;

FIG. 8 is an exploded perspective view of the LED base for the Example;

FIG. 9 is a side view of a lightguide for the Example;

FIG. 10 is a perspective view of the assembled luminaire for the Example;

FIG. 11 is a graph of a light output distribution for the Example; and

FIG. 12 is a graph of a light output distribution for the Example.

### DETAILED DESCRIPTION

A shaped luminaire includes at least one light source and a lightguide where light from the light source is coupled into the lightguide and transported by total internal reflection until it exits the lightguide. As a result of the lightguide shape, at particular locations on the lightguide not all light will be reflected due to total internal reflection and will instead exit the lightguide. The shape of the luminaire can include different levels of shape scales to control the light distribution. On a large scale the shape is the form of the lightguide, such as a cone, pyramid, or other shape. On a smaller scale the lightguide is shaped by having the cross section change. For example, in one aspect the thickness of the lightguide increases in order to collimate and inject the light efficiently into the remainder of the lightguide. In another aspect the thickness of the lightguide decreases in order to extract the light in an efficient manner. In addition to use of shape to extract light, microstructures or nanostructures on a surface of the lightguide can be used in order to further vary the extraction of light from the lightguide.

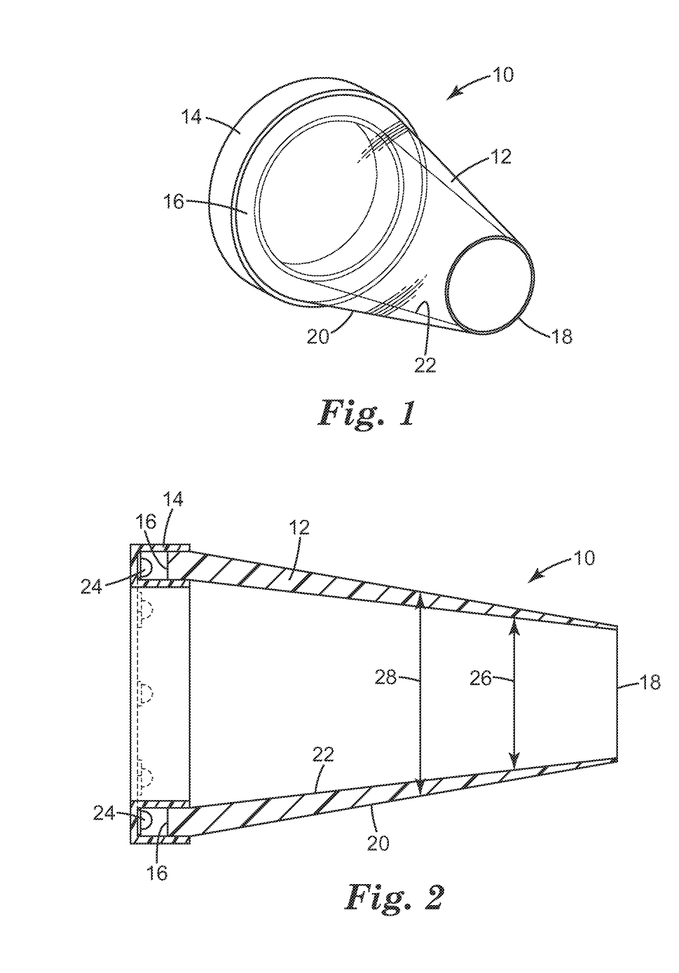

FIGS. 1-3 are perspective, side sectional, and end sectional views, respectively, of a luminaire 10. Luminaire 10 includes a lightguide 12 having an outer surface 20, an inner surface 22, a light input end 16, and a distal end 18. Solid state light sources 24, such as LEDs, are contained within a ring 14 and direct light into light input end 16. Ring 14 can be used to create a mixing cavity for light from light sources 24 to be injected into lightguide 12 with high efficiency, for example 80%, 85%, or more preferably 90%. The light injection efficiency can also be within particular ranges, for example 50% to 70%, 60% to 80%, 80% to 85%, 85% to 90%, or 90% to 95%. Ring 14 can be lined on an interior surface with a reflective film or coating to enhance the effects of the mixing cavity. As part of the mixing cavity, an air gap can be created between light sources 24 and light input end 16. The edge of lightguide 12 having light input end 16 can be secured in ring 14 through friction or use of fasteners. Further, ring 14 provides a way to efficiently remove heat from light sources 24.

Light sources 24 in ring 14 in this and other embodiments would be connected to a power source and driver for activating and controlling them. An example of a circuit for driving LEDs for a solid state light is disclosed in U.S. patent application Ser. No. 12/829,611, entitled “Transistor Ladder Network for Driving a Light Emitting Diode Series String,” and filed Jul. 2, 2010, which is incorporated herein by reference as if fully set forth. Aside from LEDs, other solid state light sources can be used such as organic light emitting diodes (OLEDs). Also, the light sources and ring can be mounted on a base providing for thermal management and cooling. For example, if the base is implemented with a metal plate, as described in the Example, the plate can function as a heat sink to conduct and dissipate heat from the light sources. Other thermal management features are possible for cooling the luminaire.

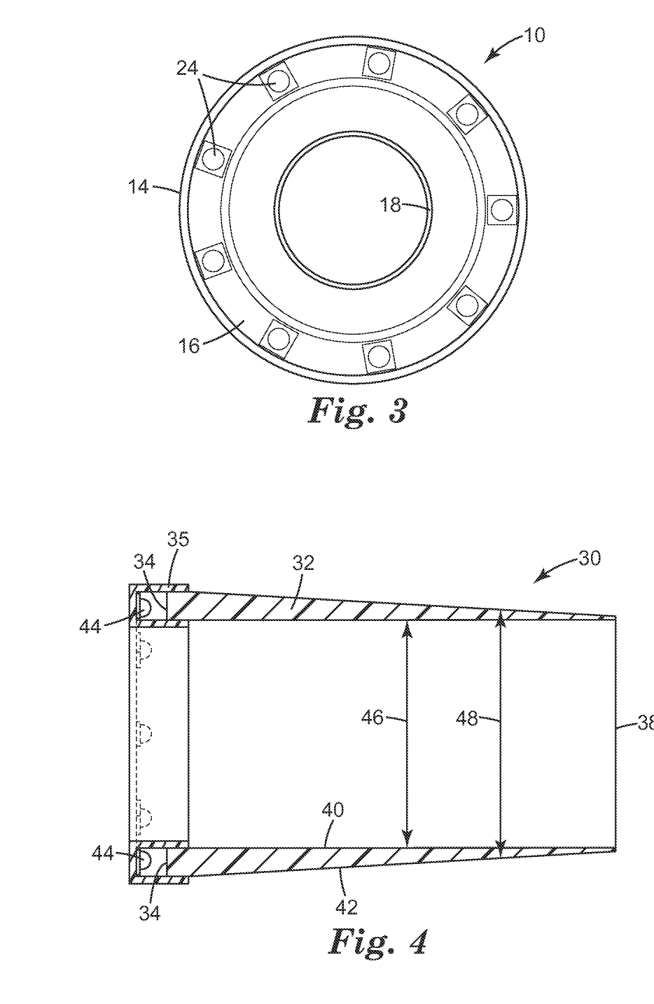

Lightguide 12 in this embodiment has a generally conical shape with an inner radius 26 and an outer radius 28 that both decrease (taper inwardly) from light input end 16 to distal end 18. In this embodiment, lightguide 12 has a continuous cross sectional shape between the light input end and the distal end, meaning the lightguide has no apertures, discrete or continuous extraction elements, or other openings from a cross sectional view as illustrated in FIG. 3.

In operation, the light from light sources 24 is injected or otherwise coupled into lightguide 12 at light input end 16 and transported within the lightguide by total internal reflection until the light exits lightguide 12, possibly along one or both of surfaces 20 and 22, and also possibly at distal end 18. A shape of lightguide 12 causes extraction of the light, and the shape directs the extracted light from lightguide 12. The shape of lightguide 12 can also cause the extracted light to exit lightguide 12 in a particular exiting light pattern. For example, such pattern can be controlled by tapering or bending lightguide 12, or both tapering and bending it, where opposing side surfaces of lightguide 12 are not parallel as shown in FIG. 2. In addition to use of shape, the exiting light pattern can also be partially controlled by features on a surface of lightguide 12. In particular, structures such as facets, lenslets, ribs, and other structures on the lightguide surface can effect light extraction and can also be aesthetic elements of the luminaire design, as well as creating desired exiting light patterns.

FIG. 4 is a side sectional view of an alternative embodiment of the luminaire of FIGS. 1-3. In FIG. 4, a luminaire 30 includes a lightguide 32 having an outer surface 42, an inner surface 40, a light input end 34, and a distal end 38. Solid state light sources 44, such as LEDs, are contained within a ring 35 and direct light into light input end 34. Ring 35 can be used to create a mixing cavity, remove heat, and be secured to lightguide 32 as described with respect to luminaire 10. Lightguide 32 in this embodiment has a generally cylindrical shape with an inner radius 46 that is substantially constant and an outer radius 48 that decreases (tapers inwardly) from light input end 34 to distal end 38. Luminaire 30 functions in a similar manner as luminaire 10 with light transported through lightguide 32 by total internal reflection and with a shape of lightguide 32 causing and directing extraction of light from lightguide 32, possibly in a particular exiting light pattern.

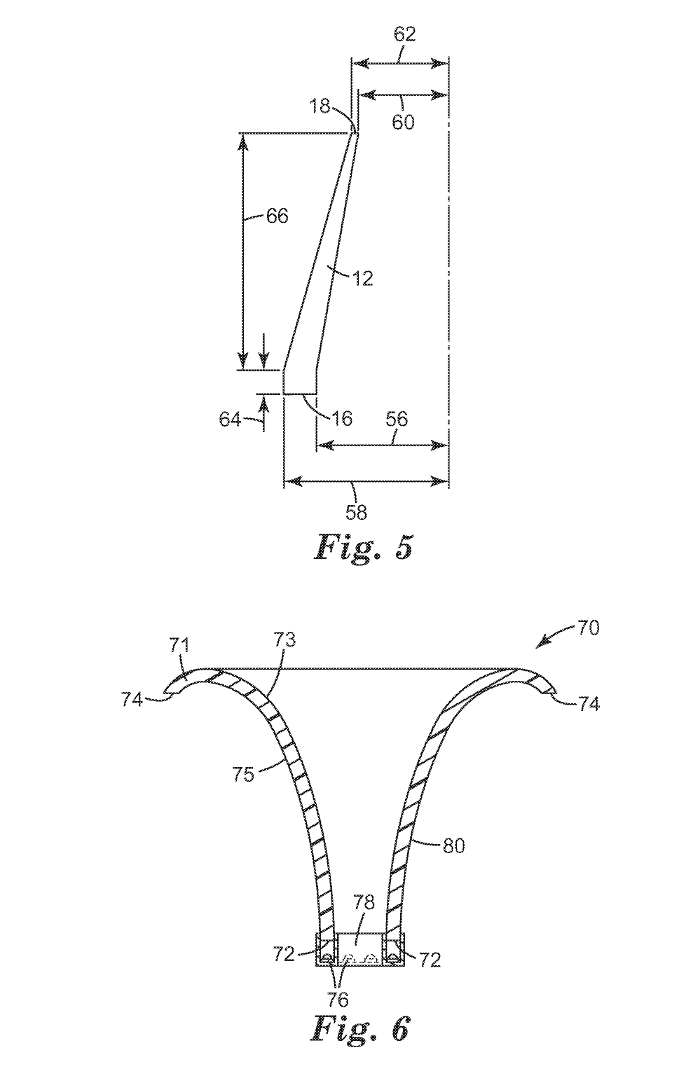

FIG. 5 is a side partial sectional view of the luminaire of FIG. 1 illustrating parameters for use in designing the luminaire. A design of this luminaire is based upon the following parameters: an inner radius 56 at ring 14 top; an outer radius 58 at ring 14 top; an inner radius 60 at lightguide 12 top; an outer radius 62 at lightguide 12 top; an overall lightguide 12 length 66; and a height 64 of a straight (non-tapered) region at the base of lightguide 12 that fits within ring 14.

These parameters can be varied in order to design a shape of the lightguide to cause extraction of light in a particular exiting light pattern. For example, the taper of the lightguide can be adjusted to make the extracted light more collimated or more dispersed. Also, the taper of the lightguide can vary in one direction, such as from the light input end to the distal end, or the taper can vary in multiple directions. The shape of the distal end can also be configured to further control the light output distribution in combination with the overall shape of the lightguide. For example, rather than being flat, the distal end can have a scalloped, sawtooth, or other non-flat shape.

The shape of the lightguide alone can thus cause the extraction of light from it, possibly in a particular exiting light pattern, as determined by these parameters. Therefore, using the shape of the lightguide to extract light makes the luminaire possible as a stand-alone device. The source of light (the bulb or light source) and the fixture need not necessarily be separate entities in order to create a useful, designed luminaire. Alternatively, the extraction of light can be caused by the shape of the lightguide in conjunction with other features such as microstructures, nanostructure, or coatings on a surface of the lightguide, in which case the light can be extracted from multiple sides of the lightguide. The luminaire can optionally include multiple lightguides each individually functioning as luminaires.

Although a round shape is shown for causing light extraction, the lightguide can include other types of shapes causing and directing the light extraction. For example, the lightguide can have a rectangular cross sectional shape between the light input end and the distal end with the lightguide tapering inwardly (becoming narrow) from the light input end to the distal end. This tapered shape can cause a particular light extraction along the lightguide surfaces between the light input end and the distal end with a remaining portion of light extracted at the distal end. Several of these rectangular lightguides can optionally be mounted adjacent one another to design a chandelier type light with the individual lightguides as the luminaires in the light. Other types of shapes for lightguides as luminaires are also possible.

Although the round shape is shown having an opening at the distal end, the lightguide need not have an opening at the distal end. For example, the distal end of the lightguide may come to a point (similar to a cone), a curved region (similar to an acorn), a flat region (similar to a truncated spheroid), or any other closed shape.

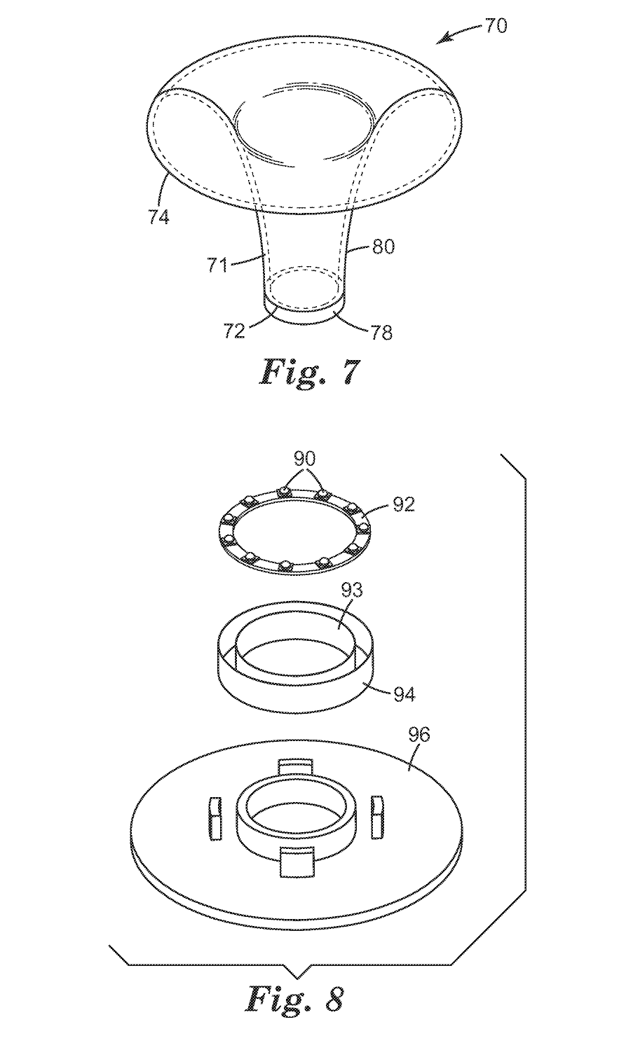

FIGS. 6 and 7 are side sectional and perspective views, respectively, of another luminaire 70. Luminaire 70 includes a lightguide 71 having an outer surface 75, an inner surface 73, a light input end 72, and a distal end 74. Solid state light sources 76, such as LEDs, are contained within a ring 78 and direct light into light input end 72. Ring 78 can be used to create a mixing cavity, remove heat, and be secured to lightguide 71 as described with respect to luminaire 10. In operation, the light from light sources 76 is coupled into lightguide 71 at light input end 72 and transported within lightguide 71 by total internal reflection until the light exits lightguide 71 at distal end 74. A shape of lightguide 71 causes extraction of the light, and the shape directs the extracted light from lightguide 71. In particular, by controlling taper of lightguide 71 as a function of distance through stem portion 80 and controlling the amount of bend in lightguide 71, light can be made to traverse lightguide 71 and exit in a desired pattern, possibly from one or both of surfaces 73 and 75, and also possibly from distal end 74. In contrast to luminaire 10 where the light exits away from the light input end, in luminaire 70 some of the light exits toward the light input end. By varying the shape of the lightguide, light can be made to extract preferentially toward or away from the light input end. Furthermore, by varying the shape of the lightguide, light can be made to extract preferentially in any radial pattern and with any angular distribution.

The luminaires can include various optional features. A diffuser can be included over the distal end of the lightguide. The lightguide can also include various coatings for color effects or other purposes. Microstructures or nanostructures, possibly distributed within a pattern, can be included on a surface of the lightguide to extract light in conjunction with the extraction caused by the lightguide shape. The microstructures or nanostructures can include scattering or refracting features. Also, the light from the light sources can be at least partially pre-collimated in order to control extraction of the light in one direction along with lightguide shape to control extraction in another direction. If multiple different colored light sources such as LEDs are used, each color can be pre-collimated to a certain degree, and the light input end of the lightguide can include multiple injection regions for the various colors in order to facilitate a desired light output color and pattern.

The lightguide can optionally include a functional coating applied to one or more of its surfaces. Examples of functional coatings include the following. Coatings with optical functions include coatings to provide for anti-reflection, radiation shielding, photoluminescence, and IR emission for passive temperature control. Coatings with physical and mechanical functions include coatings to provide for anti-abrasion, scratch resistance, and hard coats. Coatings with chemical and thermodynamic functions include coatings to provide for dirt repellence, anti-fingerprint, and anti-corrosion. Coatings with biological functions include coatings to provide for anti-microbial properties. Coatings with electromagnetic solid state functions include coatings to provide for anti-static and electromagnetic shielding.

The Examples provide exemplary materials and components for implementing the luminaire, although other types of materials and components can be used.

### Example

A luminaire was produced such that the shape of the lightguide controlled the light output distribution.

As shown in FIG. 8, 11 warm-white LEDs 90 (Cree XPEHEW-01, XPE Series high efficiency white, 3000K available from Cree Inc., Durham, N.C.) were disposed on a metal core printed circuit board 92, which formed a light source. The printed circuit board was then attached onto an aluminum base 96, which included an inner cylindrical wall and outer cylindrical wall segments, where the outer surface of the inner wall has been covered with a ring of multilayer polymeric mirror film 93 (VIKUITI ESR film available from 3M Company, St. Paul, Minn.).

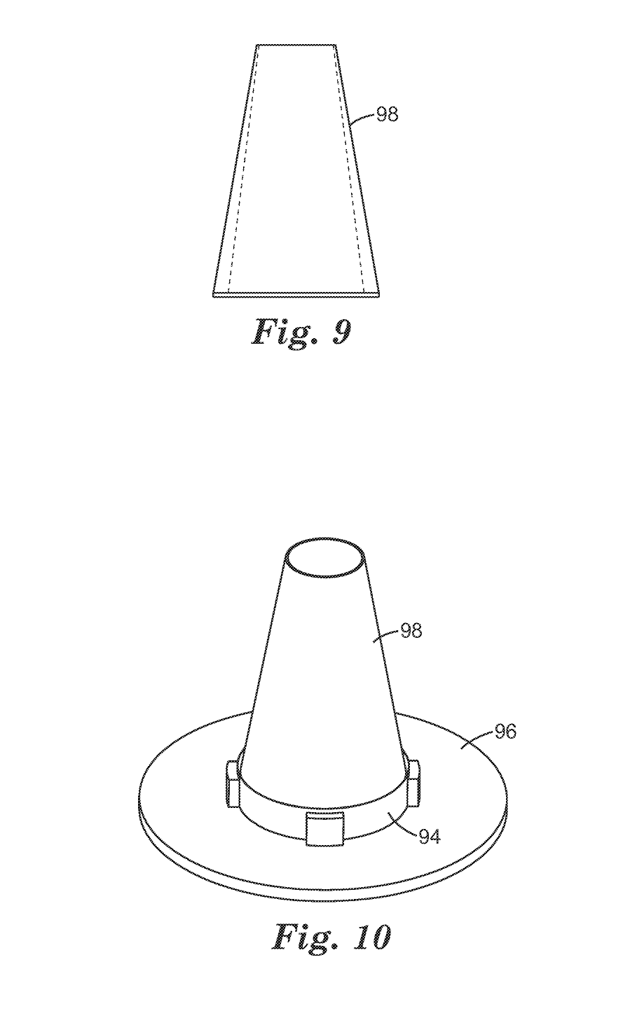

As shown in FIG. 9, a lightguide 98 was machined from a clear cast acrylic rod 7.6 cm×183 cm (available from Spartech Townsend (Spartech Corporation), Pleasant Hill, Iowa) to the following specification: the top had a 19 mm outer diameter and 18 mm inner diameter; the bottom had a 40 mm outer diameter and 32 mm inner diameter; and the lightguide had an overall height of 61 mm. All surfaces of the lightguide were then polished to a visible clear finish using the following procedural steps in the order given and with the identified products from 3M Company: keeping the surface moist with deionized water, buff the entire surface with a 3M Trizact P1000 foam disc; keeping the surface moist with deionized water, buff the entire surface with a 3M Trizact P3000 foam disc; apply 3M Rubbing Compound 39002 and buff with a 3M 298× Polishing Film until dry (repeat this step once or twice); and apply 3M Finesse-it Final Finish 82876 and buff with a 3M 298× Polishing Film.

As shown in FIG. 10, the lightguide was then placed over the LEDs, in physical contact with the inner wall. A second ring of ESR 94, of similar height but larger diameter compared to the first ring 93, was then placed between the bottom edge of the lightguide and the inner surfaces of the outer wall segments. Power was supplied to the LEDs to light the luminaire. The current delivered to the LEDs was 350 mA, and the voltage was 33 V (within ±10%).

To determine the results, the light output and distribution of the luminaire was measured. The total luminous flux of the luminaire was measured to be 760 lumens using a Gooch & Housego OL 770-LED Test and Measurement System (available from Gooch & Housego Ltd, Somerset, UK) connected to a 2 meter diameter integrating sphere. The output of the LEDs installed in the aluminum base without the lightguide present was measured to be 875 lumens.

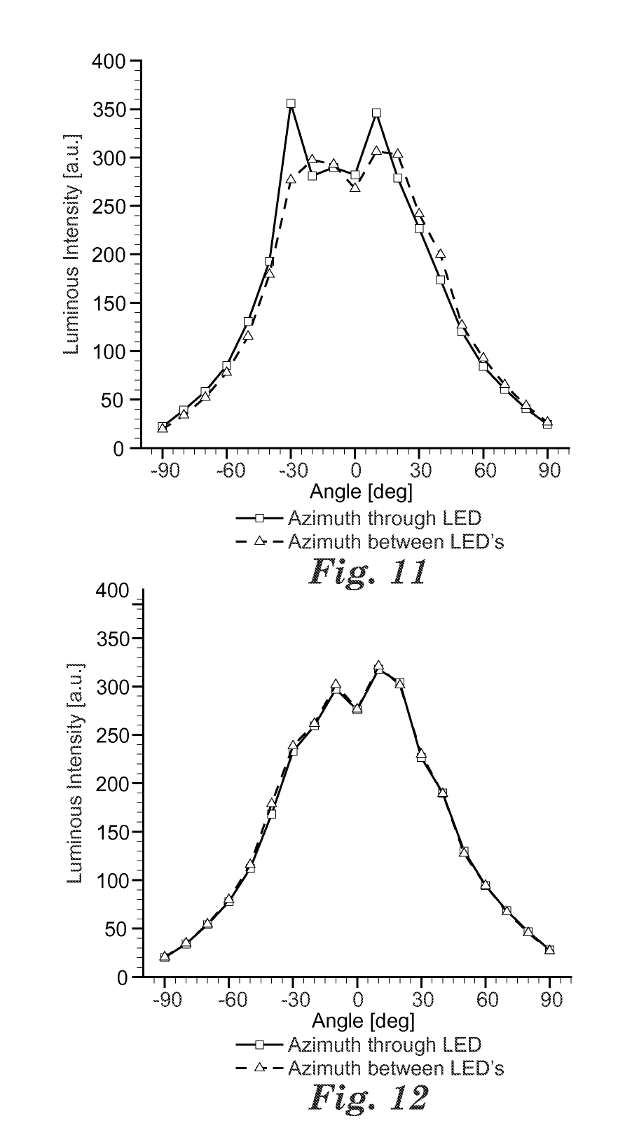

The angular output distribution of the luminaire is shown in FIGS. 11 and 12. The luminous intensity was measured on a Westar FPM-520 measurement system (available from Westar Display Technologies, Inc. St. Charles, Mo.). FIG. 11 shows the output distribution for the system as described above. FIG. 12 shows the output distribution with the addition of a mildly diffusing circular disk (approximately 19 mm in diameter) on the top surface distal end of the lightguide.

1. A luminaire, comprising
at least one light source; and
a lightguide configured to receive light from the at least one solid state light source,
wherein the light from the at least one solid state light source is coupled into the lightguide and transported within the lightguide by total internal reflection until the light exits the lightguide,
wherein a shape of the lightguide causes extraction of the light from the lightguide and the shape directs the extracted light from the lightguide.

2. The luminaire of claim 1, wherein the light source comprises a solid state light source.

3. The luminaire of claim 2, further comprising a reflective film located adjacent the solid state source to enhance coupling of the light from the solid state light source into the lightguide.

4. The luminaire of claim 2, wherein the light from the at least one solid state light source is coupled into the lightguide with an efficiency of at least 80%.

5. The luminaire of claim 1, wherein the lightguide has a first end and a second end opposite the first end, and wherein the light enters the lightguide at the first end and exits the lightguide at the second end.

6. The luminaire of claim 1, wherein the light transported within the lightguide exits at multiple sides of the lightguide.

7. The luminaire of claim 1, wherein the light exits the lightguide in an exiting light pattern determined by the shape of the lightguide.

8. The luminaire of claim 7, wherein the exiting light pattern is at least partially controlled by tapering the lightguide.

9. The luminaire of claim 7, wherein the exiting light pattern is at least partially controlled by bending the lightguide.

10. The luminaire of claim 7, wherein the exiting light pattern is at least partially controlled by features on a surface of the lightguide.

11. The luminaire of claim 10, wherein the features comprise a pattern of scattering features on the surface of the lightguide.

12. The luminaire of claim 10, wherein the features comprise a pattern of refracting features on the surface of the lightguide.

13. The luminaire of claim 1, further comprising a functional coating applied to the lightguide.

14. A luminaire, comprising
at least one solid state light source; and
a lightguide having a light input end and a distal end, and configured to receive light from the at least one solid state light source,
wherein the light from the at least one light source is coupled into the lightguide at the light input end and transported within the lightguide by total internal reflection until the light exits the lightguide,
wherein the lightguide has a continuous cross sectional shape between the light input end and the distal end,
wherein a shape of the lightguide causes extraction of the light from the lightguide and the shape directs the extracted light from the lightguide.

15. The luminaire of claim 14, wherein the lightguide directs the extracted light in a direction away from the light input end.

16. The luminaire of claim 14, wherein the lightguide directs the extracted light in a direction toward the light input end.

17. The luminaire of claim 14, wherein the light from the at least one solid state light source is coupled into the lightguide with an efficiency of at least 80%.

18. The luminaire of claim 14, wherein the light exits the lightguide in an exiting light pattern determined by the shape of the lightguide.

19. The luminaire of claim 18, wherein the exiting light pattern is at least partially controlled by tapering the lightguide.

20. The luminaire of claim 18, wherein the exiting light pattern is at least partially controlled by bending the lightguide.

21. The luminaire of claim 18, wherein the exiting light pattern is at least partially controlled by features on a surface of the lightguide.

22. The luminaire of claim 21, wherein the features comprise a pattern of scattering features on the surface of the lightguide.

23. The luminaire of claim 21, wherein the features comprise a pattern of refracting features on the surface of the lightguide.

24. The luminaire of claim 5, further comprising a diffuser over the second end of the lightguide.

25. The luminaire of claim 14, further comprising a diffuser over the distal end of the lightguide.
